(19) United States
(12) Patent Application Publication
(10) Pub. No.: US 2013/0241129 A1
(43) Pub. Date: Sep. 19, 2013

(54) SAFETY CLAMPING DEVICE

(71) Applicant: Klaus Hofmann, Bruck (DE)

(72) Inventor: Klaus Hofmann, Bruck (DE)

(21) Appl. No.: 13/823,097

(22) PCT Filed: Sep. 15, 2011
(86) PCT No.: PCT/DE2011/075224

§ 371 Date: May 28, 2013

(30) Foreign Application Priority Data
Sep. 15, 2010 (DE) 10 2010 037 546.2

(51) Int. Cl. B23Q 3/08; B23Q 3/06

(52) U.S. Cl. CPC B23Q 3/08; B23Q 3/06
USPC 269/23; 269/329; 269/20

(57) ABSTRACT

The invention concerns a safety clamping system for the fastening of workpieces on machine tools, wherein, in addition to one clamping mechanism known from the state of the art, at least one positioning mechanism is also provided, which can pre-position the workpiece roughly before the affixing and move it into the final affixing position and, at the same time, can facilitate the monitoring for an undesired detachment of the workpiece.

The present invention concerns a safety clamping system for securing of workpieces during processing on a machine tool.

For the fastening of workpieces that are to be processed by a machine tool, various mechanisms are known. The fastening can be carried out, in particular, by means of clamping components fastened on the workpiece, which, in turn, can be clamped into clamping means that are provided on the machine tool (below, designated also as clamping chuck). As clamping components, one can take into consideration, in particular, clamping bolts, which are, for example, temporarily screwed with the or into the workpiece. Such systems have the advantage that the workpiece that is temporarily removed from the machine can be clamped with high repeatability or position accuracy in the machine tool without additional adjustment operations being necessary.

Such a clamping system is known from DE 10 2005 033 468 A1 or from WO 2007/009439, wherein the mechanism described in these documents for the clamping of an affixing element, which corresponds to the clamping component or the clamping bolt of the document under consideration, is to be explicitly incorporated into the disclosure content of the document under consideration.

In particular with workpieces moved during processing, care must be taken that they are not unintentionally detached from their fastening or that in such a case, immediate and preferably automatic measures are taken, so as to convert the machine to a safe state as quickly as possible.

At the same time, from the state of the art, the problem is known that the often heavy workpieces must be positioned with sufficient accuracy before the fastening or clamping on the machine, so as to be able to carry out the affixing at all (in particular, with the aforementioned clamping chuck technology). This is particularly difficult in the cases in which the workpiece is to be fastened on a vertically aligned base plate. As an example, one can take perhaps into consideration a rotational processing in which the workpiece is to be temporarily affixed on a vertically aligned base plate, wherein the base plate has one or more clamping chucks and is to be rotated around a horizontal axis. For the purpose, the workpiece is to be placed, with the clamping bolts fastened on it, on the base plate in such a way that the clamping bolts project into the clamping chucks of the base plate, so as to attain the affixing of the workpiece with the base plate or the machine tool in an accurate position with the subsequent actuation of the clamping mechanism of the clamping chucks. This pre-positioning before the affixing by the clamping chucks is from time to time difficult with heavy or unwieldy workpieces and often cannot be managed simply manually.

Therefore, the goal of the invention is to facilitate the pre-positioning of the workpiece and, at the same time, to increase the securing, so as to prevent an unintentional detachment of the workpiece.

The goal is attained with the safety clamping device according to Claim 1.

The invention proceeds from the knowledge that the pre-positioning of the workpiece before the actual affixing effected with the clamping chucks is advantageously facilitated with a positioning mechanism, which initially limits the workpiece in its movement freedom to a constructively specifiable extent before this accurate-position affixing. In this way, the workpiece, relative to a base plate used for the affixing, can be initially pre-positioned roughly and left in this position without the workpiece having to be held manually or with other external aids. Such a mechanism facilitates the placing and affixing of the workpiece on the machine tool, since the operator merely has to ensure the rough pre-positioning, after which the workpiece can be transferred without external aids to its final affixed position (below, “affixing position”) on the base place, as will be seen later.

Movable means can be provided for the pre-positioning; they grip from behind a recess in the workpiece or in a holder carrying the workpiece, so as to be able to act on the workpiece in this way with a tractive force, preferably in the direction towards the base plate or the clamping chucks.

Therefore, an embodiment of the safety clamping device in accordance with the invention comprises at least one clamping chuck, as one already known from the previously mentioned state of the art, which is, for example, incorporated into a vertically arranged base plate. The clamping chuck has an introduction opening for the holding of an affixing element connected with the workpiece, wherein this affixing element can be, in particular, a clamping bolt likewise known from the state of the art. The introduction opening extends along a first, preferably horizontal direction X, wherein the corresponding bolt affixed in the workpiece is to be introduced into the introduction opening in a manner corresponding to the X direction in order to be affixed there.

Furthermore, the safety clamping device in accordance with the invention comprises at least one positioning mechanism. The positioning mechanism is equipped with movable means, so that before the workpiece is affixed in an accurate position by the clamping chuck, it is first limited in its freedom of movement in the X direction and/or transverse to it. Moreover, the positioning mechanism can move the workpiece into the affixing position or hold it there even if the clamping chucks release the clamping bolts projecting into it, intentionally or unintentionally.

The movable means of the positioning mechanism can project by a certain amount, in particular, in the X direction from the base plate and mesh into a suitable recess of the workpiece. By means of the meshing, a relative movement of the workpiece, transverse to the movable means, that is, transverse to the X direction, is prevented in a form-locking manner, so that the workpiece can be held in this preliminary position with the aid of the positioning mechanism.

[The invention under consideration describes the (direct) affixing of a workpiece on a machine tool, wherein, on the one hand, clamping bolts for the affixing in clamping chucks and, on the other hand, recesses for the interaction with the movable means of the positioning mechanism are to be provided on the workpiece. Similarly, however, a workpiece holder can be affixed, which, in turn, carries one or more workpieces. In this case, the clamping bolts are affixed on the workpiece holder, which has, moreover, the corresponding recesses for the interaction with the movable means of the positioning mechanism. Accordingly, the fastening features described for the workpiece are equally valid for a workpiece holder used alternatively to this, on which workpieces can be fastened.]

An advantageous embodiment of the invention provides for the means of the positioning mechanism to be movable in the X direction, so that the workpiece acted on by the means is actively moved relative to the clamping chuck toward it. The result is that the means can act actively on the workpiece, so as to draw it in the direction of the clamping chuck into the affixing position, so that the clamping bolt located on the workpiece is drawn into the clamping chuck of the base plate. By means of suitable centering means on the clamping chuck and/or the positioning mechanism, the workpiece thereby experiences the exact alignment or positioning that is provided for the affixing. When the clamping chuck is actuated, the clamping bolt protruding into the clamping chuck is affixed in an accurate position in the X direction and transverse to it, so that the workpiece is fastened on the machine tool for processing.

So that the movable means of the positioning mechanism can pull the workpiece into the affixing position or hold it there, they comprise at least one pulling element, which can move from a first position L₁ in which the workpiece is freely movable in the X direction, into a second position L₂ in which the moving freedom of the workpiece in the X direction is limited to a specifiable extent (in particular, to the value zero, in which the workpiece then attains the affixing position). The pulling element thereby extends in the X direction and has a projection (hook) running transverse to it on its free end, which can mesh into a rear cut provided in the recess of the workpiece, so as to be able to act on the workpiece in the X direction with a tractive force.

An advantageous embodiment thereby provides for the at least one pulling element, while it is moved in the direction of the clamping chuck, to also be conducted transverse to the X direction, at least in sections. This ensures that the pulling element grips the rear cut in the recess of the workpiece during its pulling movement.

From the description of the figure, it will become clear that, for the purpose, especially several pulling elements arranged together into a cylinder form are suitable if their free end, in each case, is provided with a hook-like projection, projecting radially outwards. Each projection partially moves radially outward [within] the framework of the pulling movement by a specific amount, so as to grip with the hook behind the recess in the workpiece. With a simultaneous movement of the pulling elements in the X direction, the workpiece acted on by the pulling element is then moved in the direction of the affixing position to the extent that the clamping bolts fastened on the workpiece protrude sufficiently into the individual clamping chuck, so as to be clamped or affixed there.

An embodiment of the invention in accordance with the invention provides for an opening on the positioning mechanism, which functions as an orifice for a fluid (preferably, compressed air). The opening is arranged in accordance with the invention, so that it is concealed or closed by a workpiece or a closure element coupled with the movable means, when the workpiece has assumed the affixing position and can thereby be affixed, but need not be affixed, into the individual clamping chucks by means of its clamping bolts.

The opening can be used advantageously for the purpose of monitoring the flowing out of the fluid, and drawing therefrom conclusions as to whether the workpiece is still held securely in the affixing position by the positioning mechanism. Then, the opening is closed by the workpiece or an element interacting directly or indirectly with it, and the fluid does not flow out. If, however, the workpiece could possibly undesirably detach or even has become detached from the positioning mechanism, the opening will no longer be closed by the workpiece, pulling element, actuation air, or something similar, and the fluid will then flow out. In accordance with the invention, the monitoring of the flow conditions will be used to release the machine tool for operation or to then convert it to a safe operating state if a flow of the fluid is determined, which indicates an undesired detachment of the workpiece.

The monitoring of a fluid flow can be carried out by various sensors or controls known to the specialist. A simple variant provides for using a throttle within the supply line of the fluid and to continuously monitor the pressure conditions upstream and downstream from the throttle with suitable pressure sensors. If the workpiece is held securely in the affixing position, that is, the opening is closed and accordingly, no fluid can flow out, then the pressures on both sides of the throttle will have approximately the same magnitude. If, on the other hand, as a result of an unintentional detached workpiece or moved pulling element, a flow is produced, then it is possible to measure a pressure gradient upstream and downstream from the throttle via the pressure sensors. A suitable evaluation unit can generate a control signal therefrom for the immediate turning off of the machine tool, and thus prevent the machine or even a person from being harmed by the detached workpiece, which may perhaps be hurled forth in an uncontrolled manner.

In a refinement of this inventive idea, another embodiment of the invention provides for an opening on the clamping chuck, where a supply for a fluid leads to. This opening also should be closed with the workpiece or a closure element coupled with it. In particular, the opening should then be closed if the workpiece is affixed with the clamping bolt(s) in the clamping chuck(s). On the other hand, if the workpiece is detached from the clamping chuck provided with the opening, then in a manner analogous to the positioning mechanism, the fluid can flow out here also. In the same manner as for the positioning mechanism, the flow can also be monitored for the clamping chuck and if necessary, lead to a turning off of the machine tool if the unintentional detachment of the workpiece allows the fluid to flow out from the opening on the clamping chuck.

A particularly simple and appropriate securing function is given in that the two supply lines to the clamping chuck or to the positioning mechanism communicate with one another, that is, in particular, can be acted on simultaneously with a fluid. In this way, it is possible to simultaneously monitor the two fluid strands, so that the turning off of the machine tool can be triggered when either the opening on the clamped chuck and/or the opening on the positioning mechanism is released and causes a flow of the fluid.

One embodiment of the invention provides for the supply line, in continuation of the previously described arrangement of the throttles and the pressure sensors, to be divided downstream from the throttles into a conduit or supply line, which leads to the clamping chuck, whereas the second line or supply line leads to the positioning mechanism. If each of the two supply lines is closed at its end, that is, in the area of the opening on the clamped chuck or on the positioning mechanism, then a flow does not appear and the machine tool machine can be driven. If, on the other hand, in at least one of the two supply lines downstream from the common throttle, a flow appears, then the previously described arrangement of the pressure sensor will recognize a decline in pressure, whose evaluation can be put to use to turn off the machine tool. Such an arrangement of the supply lines to the clamped chuck and to the positioning mechanism, in which the two supply lines are branched off from a common supply line that has pressure monitoring, can be implemented with a simple design and increases in a particularly advantageous manner safety with respect to an unintentional detachment of a workpiece.

One embodiment of the safety clamping device in accordance with the invention will be explained in more detail below with the aid of a description of the figures.

The figures show the following:

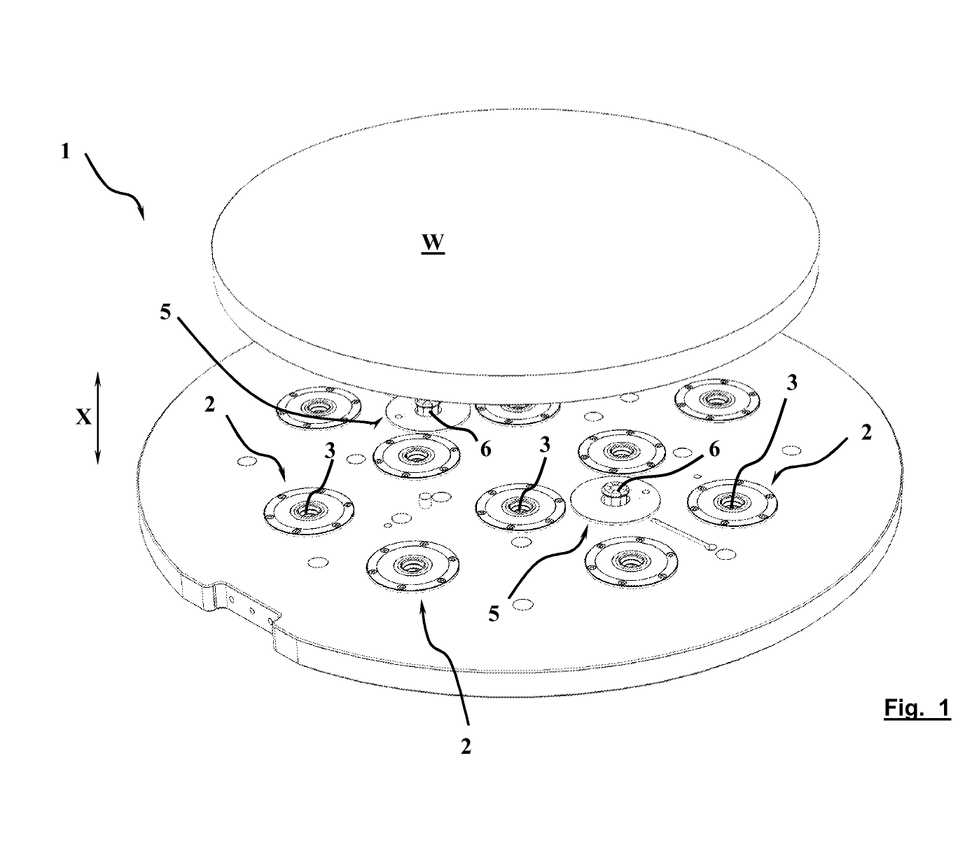

FIG. 1, a perspective view of a base plate with clamping chucks and positioning mechanisms;

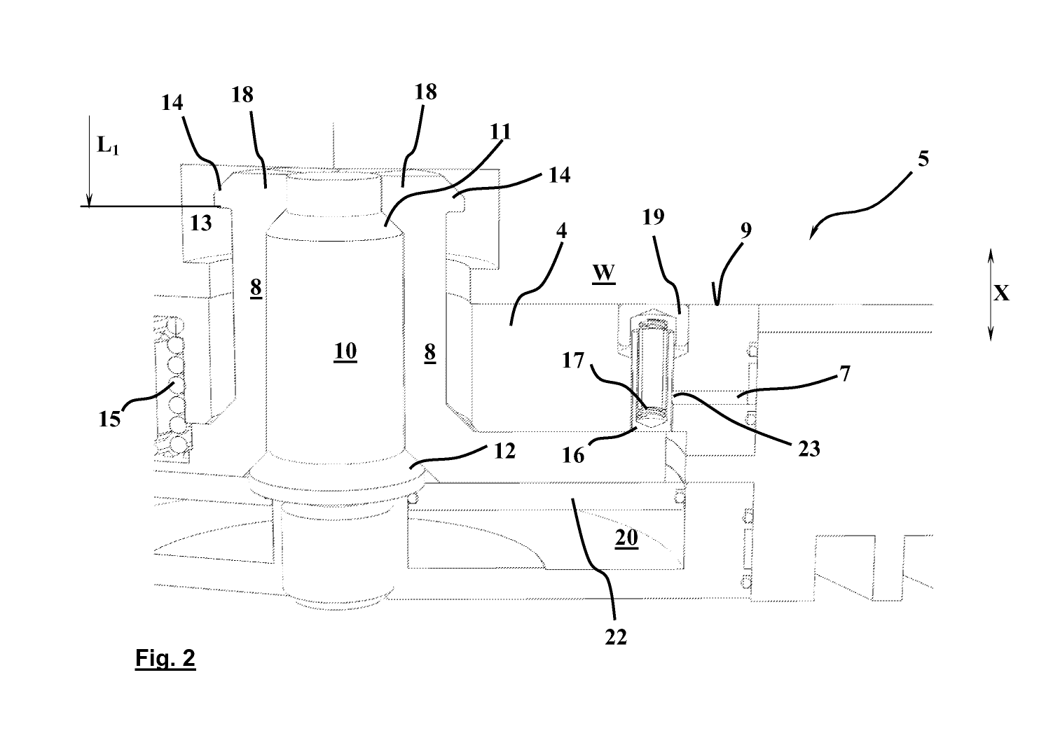

FIG. 2, a sectional representation of a positioning mechanism with a workpiece not in use; and

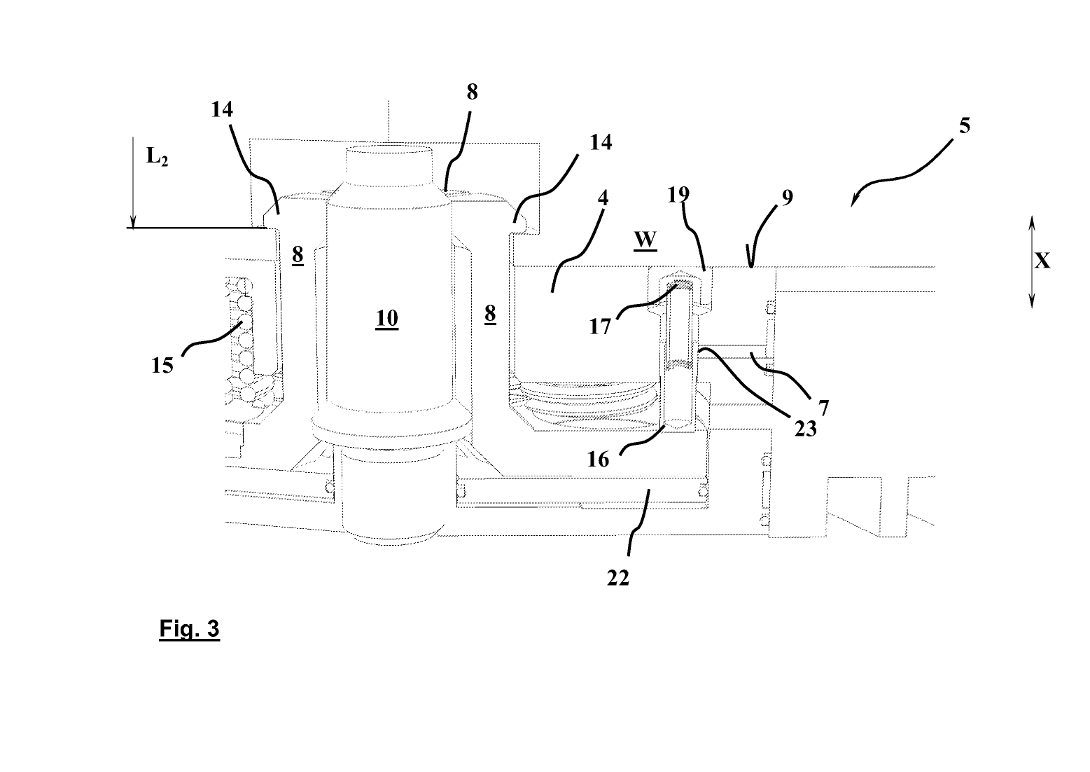

FIG. 3, the positioning mechanism in accordance with FIG. 2 with a workpiece in use.

FIG. 1 shows an essentially circular base plate, which is designed around a rotational axis X and has several clamping chucks 2. Each clamping chuck 2 has an introduction opening 3 into which an affixing element (in particular, a known clamping bolt, not depicted in the figures) can be introduced for clamping or affixing, wherein the affixing element is affixed, in turn, on a workpiece. The base plate is used for the affixing of workpieces on a machine tool and can, in particular, be driven by the machine tool for rotation around its rotational axis running in the X direction, for example, in order to carry out rotational processing on the workpiece affixed on the base plate. For this purpose, the base plate can also be aligned in such a manner that its rotational axis runs horizontally.

In addition to a total of ten clamping chucks 2 known from the state of the art, the safety clamping device 1 in accordance with the invention and according to FIG. 2 also has two positioning mechanisms 5. The positioning mechanisms 5 essentially lie in the same plane as the clamping chucks 2. Each positioning mechanism 5 comprises movable means 6 in the form of pulling elements 8 in its center, which can mesh into the recess of a workpiece, so as to align it within the framework of a rough pre-positioning, so that the clamping bolts fastened on the workpiece W can be introduced into the introduction openings 3 of the clamping chucks 2 and finally, can be clamped there.

FIG. 2 shows a schematic sectional representation of a positioning mechanism 5. The positioning mechanism 5 comprises a stop plate 4 essentially with the shape of a circular disk, whose upper stop surface 9 is located in the base place in accordance with FIG. 1 approximately flush to the upper side of the clamping chucks 2. Several pulling elements 8 protrude from the stop plate 4 in the X direction in the center of the stop plate 4. The pulling elements 8 are movable in the X direction and are located around a mandrel 10 lying in the center of the stop plate 4. The mandrel 10 has two heels 11, 12 shaped as conical extensions, which interact with inclines constructed complementary to them on the side of each pulling element 8 turned toward the mandrel 10. In their completely moved-out position, the pulling elements, relative to their X position, assume a first end position L₁.

The spring mechanism 15 presses the free ends 18 of each pulling element 8 protruding upwards from the stop plate 4 downwards in the direction of the stop plate 4. Hooks 14 constructed on the free ends 18 of the pulling elements 8 move, on the one hand, from the first end position L₁ downwards in the X direction, and on the other hand, the pulling elements 8 experience a translatory movement with a radial fraction transverse to the X direction outwards as a result of the conical projections 11 and 12. Within the framework of this radial movement, the hooks 14 grip from behind a rear cut formed in a recess 13 of this workpiece W, so that the pulling element 8 can exert a tractive force in the X direction of the stop plate 4 on the workpiece W.

While the pulling elements 8 move in the X direction downwards, they slide with their surfaces constructed complementary to them along the conical heels 11, 12 of the mandrel 10, wherein the simultaneous radial movement of the pulling elements 8 is effected. As soon as the conical heels 11, 12 and the sections complementary to them have slid completely past the pulling elements 8, the other downward movement of the pulling elements 8 takes place exclusively in the X direction. By this time, the hooks 14 have already gripped the rear cut in the recess 13 of the workpiece W to a sufficient extent so as to act on the workpiece in the X direction and pull it down, if possible, to the affixing position.

The position of the pulling elements or the workpiece shown in FIG. 2 makes clear that the workpiece is limited in its moving freedom in the X direction and also transverse to it by the pulling elements 8 and thus is already roughly pre-positioned with respect to the attainable firm affixing of the workpiece on the clamping chucks 2 in accordance with FIG. 1.

One can see in FIG. 3 that the pulling elements 8 have assumed on their further path in the X direction an end position L₂, in which the workpiece W was pulled down to the stop surface 9, and with respect to the clamping chucks 2, assumes the affixing position. In this position, the clamping bolts of the workpiece W, which are not depicted in more detail, protrude completely into the clamping chucks 2 of the base plate in accordance with FIG. 1, and by the actuation of the clamping mechanisms of the clamping chucks, are affixed therein, securely and in an accurate position, for subsequent processing.

The spring mechanism 15 shown in FIGS. 2 and 3 for the actuation of the pulling elements 8 can be appropriately actuated by the actuation of compressed air. A displacement volume 20 closed by a piston 22 can be acted on with compressed air, wherein the pulling elements 8 adjacent to the piston 22 can move out against the spring force in the X direction from the positioning mechanism. On the other hand, if the displacement volume 20 is relieved, then the springs press the pulling elements 8 in the opposite direction downwards once again, wherein a workpiece W gripped by the hooks 14 of the pulling elements 8 is tightened. This mechanism advantageously ensures that the pulling elements 8 always hold the workpiece W, if the displacement volume 20 was not impinged with compressed air or it has perhaps unintentionally failed.

The stop plate 4 has a borehole, in which a pin 16 is guided, moved in the X direction. A spiral spring 17 projecting into the interior of the pin 16 is thereby supported via a closure cap 19 on the stop plate 4 and thereby presses the pin 16 downwards. With its free end protruding downwards, the pin 16 lies next to a flange-shaped extension of a pulling element 8, so that the pin 16 follows the movements of the pulling element 8 in the X direction.

With the arrangement shown in FIG. 2, the pulling elements 8 assume the first end position L₁, wherein the pin 16 is pushed completely into its borehole that guides it within the stop plate 4. This position of the pin 16 represents the state in which the workpiece W is not forcibly held, clamped or secured by the pulling elements 8 against the stop plate 4. In the state shown in FIG. 3, on the other hand, in which the pulling elements 8 assume the second end position L₂, the pin 16 projects by a certain extent from its guide borehole downwards. This position represents the state in which the workpiece W is securely clamped by the pulling elements 8 in the affixing position and against the stop plate 4.

Along its longitudinal axis, the pin 16 has two areas with different outside diameters. In its lower area, the diameter of the pin 16 opposite the upper area is slightly reduced, which leads to an annular slot between the pin 16 and its borehole in this area. The second section of the pin 16 lying above it has an outside diameter, which largely corresponds to the inside diameter of the borehole guiding the pin, so that the pin can be easily moved, but without appreciable play within the borehole.

A supply line 7 radially leads to the opening 23 into the borehole guiding the pin 16. A fluid, in particular, compressed air, can be conducted through a conduit of this supply line 7, which is not subsequently depicted, in order to detect a flow through the supply line 7 and perhaps to process it as a turning off criterion for the machine tool. In the position shown in FIG. 2, in which the workpiece W is not firmly clamped against the stop plate 4, the pin 16 lies in the X direction in such a way that the section communicates with a lower outside diameter or the annular space with the mouth of the supply line 7, that is, the opening 23 is not closed. A medium external to the supply line 7 can therefore flow into the annular space and flow off through a removal line that is not shown in more detail. Since the pin 16, therefore, does not block the flow of the fluid in this position, the detected flow can be evaluated as a signal that the pulling elements 8 do not securely clamp the workpiece W against the stop plate 4.

In FIG. 3, on the other hand, the workpiece W is firmly clamped against the stop plate 4 by the pulling element 8 pulled down into the second end position L₂. Accordingly, the pin 16 is followed by the downward movements of the pulling elements 8, so that now the section with the expanded outside diameter of the pin 16 covers or closes the opening 23 on the mouth of the supply line 7. Accordingly, a medium supplied external to the supply line 7 can no longer flow out into the borehole. This circumstance can be processed by the previously described evaluation or control unit as an indication that the workpiece W is securely clamped against the positioning mechanism 5.

Alternatively, the supply line 7 could have also been designed so that its mouth can be closed directly by the workpiece W. In this case, an air flow, however, appears only if the workpiece has actually released the supply line 7, that is, has moved relative to the positioning mechanism 5. In the embodiment in accordance with FIGS. 2 and 3, on the other hand, the supply line 7 is opened or blocked as a function of the position of the pulling elements 8, so that a possible detachment of the workpiece W can be promptly detected.

The positioning mechanism in accordance with the invention functions in the following manner:

By the impingement of the piston 22 with compressed air against the spring mechanism 15, the pulling elements 8 are moved out upwards from the stop plate 4 and on in the X direction. They slide thereby along the mandrel 10 and finally assume a position in the first end position L₁ radially close to one another. A workpiece W with a recess 13 provided therein is pushed over the pulling elements 8 for the purpose of rough pre-positioning, so that a movement of the workpiece W transverse to the X direction by the pulling elements 8 is limited to a small amount.

Subsequently, the displacement volume 20 is relieved so that the springs 15 relax and the pulling elements 8 thereby move down in the opposite direction along the mandrel 10. The pulling elements 8 spread thereby in the radial direction by movement along the conical sections 11 and 12 of the mandrel 10, wherein the hooks 14 of the pulling elements 8 grip from behind a rear cut in the recess 13 of the workpiece. With an additional downward movement of the pulling elements 8, the workpiece W is pushed into the affixing position automatically in the direction of the stop surface 9 (in which the clamping bolts protrude into the clamping chucks 2 of the base plate in accordance with FIG. 1). With the attaining of the end position L₂, the workpiece W lies on the stop surface 9 of the positioning mechanism 5 and can simultaneously be affixed via its clamping bolts into the clamping chucks 2 in accordance with FIG. 1.

If the workpiece 10 should be unintentionally detached from the position shown in FIG. 3, then the pin 16 releases the mouth of the supply line 7, wherein compressed air can flow out of the opening 23. This flow can be used by the aforementioned monitoring for the immediate turning off of the machine tool (in particular, the end of the rotational movement of the base plate), so as to bring the machine to a safe operational state and to prevent harm to persons and the machine by workpieces that are hurled out in an uncontrolled manner.

A comparable securing mechanism can also be provided on the clamping chucks in accordance with the invention. From a supply line 70 leading into the clamping chuck, fluid can also then flow out, if the workpiece should be unintentionally detached, which should likewise lead to a turning off of the machine tool. Advantageously, both securing mechanisms can be coupled with one another. Pressure monitoring by means of sensors can then be provided in accordance with the invention in a (common) conduit section communicating with both supply lines, so that an undesired pressure decline in one of the two or also in both supply lines can be simultaneously detected by the common sensor system and can be evaluated.

With the safety clamping device in accordance with the invention, on the one hand, the affixing of workpieces on machine tools is simplified, while, on the other hand, the undesired detachment of workpieces can be detected in a particularly reliable manner in that the pulling elements both clamp the workpiece and influence the air flow.

1. Safety clamping device (1) for the temporary clamping of workpieces (W),
a) with at least one clamping chuck (2) for the affixing of the workpiece (W) in an exact position;
b) wherein the clamping chuck (2) has an introduction opening (3) to hold an affixing element (4) connected with the workpiece (W), and wherein the introduction opening (3) extends along a first, preferably, horizontal direction (X); characterized in that
c) the safety clamping device (1) has in addition to at least one clamping chuck (2) at least one positioning mechanism (5) interacting with the workpiece (W) and comprising movable means (6), so as to initially limit the workpiece (W) to one area, before it is affixed in an exact position by the clamping chuck (2), in its movement freedom in the X direction and/or transverse to it.

2. Safety clamping device according to claim 1, characterized in that the means (6) can be moved in the X direction, so as to actively move the workpiece (W), impinged on by the means (6), relative to the clamping chuck (2), toward it.

3. Safety clamping device according to one of the preceding claims, characterized in that the movable means (6) comprise at least one pulling element (8) with a hook, so as to be able to grip from behind a rear cut provided in a recess of the workpiece, in order to be able to impinge on the work piece in the X direction with a tractive force.

4. Safety clamping device according to one of the preceding claims, characterized in that the means (6) comprise at least one pulling element (8), wherein the pulling element (8) can be moved from a first position (L₁), in which the workpiece (W) is freely movable in the X direction, into a second position (L₂), in which the movement freedom of the workpiece (W) is limited in the X direction to a prespecified extent, in particular, to the value 0.

5. Safety clamping device according to the preceding claim, characterized in that the means are selected in such a manner that they limit the movement freedom of the workpiece (W) transverse to the X direction in the first and the second position (L₁, L₂) of the pulling element (8).

6. Safety clamping device according to one of the preceding claims, characterized in that a supply line (7) for a fluid leads to an opening (23) on the positioning mechanism (5), wherein the opening (23) can be closed by the workpiece (W), the movable means (6), or a closure element (16) coupled with it, in particular, by a movement of the workpiece (W) in the X direction toward the clamping chuck (2).

7. Safety clamping device according to the preceding claim, characterized in that a supply line (70) for a fluid also leads to an opening on the clamping chuck (2), with the possibility of closing the opening with the workpiece (W) or a closure element coupled with it, in particular, by movement of the workpiece (W) in the X direction toward the clamping chuck (2).

8. Safety clamping device according to the preceding claim, characterized in that the two supply lines (7, 70) communicate with one another, so that they can act simultaneously with fluid.

9. Machine tool to hold a safety clamping device according to one of the preceding claims 5-7, characterized in that a control unit is provided for the monitoring of an unintentional opening of at least one of the two openings, so as to then convert the machine into a safe operating state.

10. Machine tool according to the preceding claim, characterized in that for the monitoring of the openings, at least one pressure sensor is provided in the supply line (7, 70) or in a feed line jointly supplying both conduits.
